(19) United States
(12) Patent Application Publication
(10) Pub. No.: US 2012/0176300 A1
(43) Pub. Date: Jul. 12, 2012

(54) PIXEL STRUCTURE AND DISPLAY PANEL

(75) Inventor: Tsung-Hsien Lin, Taichung City (TW)

(73) Assignees: WINTEK CORPORATION, Taichung City (TW); WINTEK (CHINA) TECHNOLOGY LTD., Guangdong Province (CN)

(21) Appl. No.: 13/346,671

(22) Filed: Jan. 9, 2012

(30) Foreign Application Priority Data
Jan. 10, 2011 (TW) 100100840

(51) Int. Cl. G09G 3/36

(52) U.S. Cl. 345/87

(57) ABSTRACT

A pixel structure and a display panel are provided. The pixel structure is disposed on a substrate having a transmissive display region and a reflective display region and includes a scan line, a data line, an active device, a first electrode, a second electrode, and an alignment layer. The first electrode has first stripe portions located in the transmissive display region and second stripe portions located in the reflective display region. Each first stripe portion and each second stripe portion are perpendicular arranged. One of the first electrode and the second electrode is electrically connected to the active device and the other of the first electrode and the second electrode is connected to a common voltage. The alignment layer covers the first electrode and the second electrode and has an alignment direction intersecting the second direction in 45° to 85°.

### CROSS-REFERENCE TO RELATED APPLICATION

This application claims the priority benefit of Taiwan application serial no. 100100840, filed on Jan. 10, 2011. The entirety of the above-mentioned patent application is hereby incorporated by reference herein and made a part of this specification.

### BACKGROUND OF THE INVENTION

1. Field of the Invention

The invention relates to pixel structure and display panel, and more particularly, to a trans-reflective pixel structure and display panel.

2. Description of Related Art

Recently, with the development of the liquid crystal display panel, thin film transistor liquid crystal displays (TFT-LCDs) having the characteristics of good image quality, thin volume, low power consumption, and low radiation has gradually replace cathode ray tube (CRT) displays to become the main streamed product in the display market. The LCDs can be categorized into two types based on the utilization of the light source, such as the transmissive type and the reflective type. The transmissive type LCD uses a back light as the display light source and the reflective type LCD uses a front light or ambient light as the display light source.

With the widespread use of LCDs, requirements for better display performance of LCDs in many portable electronic products are gradually increased. The portable electronic products not only necessitate satisfactory display performance indoors, but also require appropriate image qualities outdoors or in a high luminance environment. Therefore, a trans-reflective LCD is provided.

Generally, the trans-reflective LCD are designed in dual cell gaps so that the transmission region and the reflective region both can have desirable display quality. The trans-reflective LCD having the dual cell gaps raises complexity in the fabrication thereof. Moreover, due to a difference of the cell gaps at the transmission area and at the reflective area, the light transmittance between the transmission area and the reflective area is rather unsatisfactory, thus reducing an overall aperture ratio.

### SUMMARY OF THE INVENTION

The invention provides a pixel structure having a trans-reflective display function.

The invention provides a display panel having a trans-reflective display function while the display medium thereof is configured in a constant thickness.

The invention provides a pixel structure disposed on a substrate. The substrate has a transmissive display region and a reflective display region. The pixel structure includes a scan line, a data line, an active device, a first electrode, a second electrode, and an alignment layer. The data line intersects the scan line. The active device is electrically connected to the scan line and the data line. The first electrode has a plurality of first stripe portions located in the transmissive display region and a plurality of second stripe portions located in the reflective display region. Each of the first stripe portions is extended in a first direction and each of the second stripe portions is extended in the second direction. One of the first electrode and the second electrode is electrically connected to the active device and the other of the first electrode and the second electrode is connected to a common voltage. The alignment layer covers the first electrode and the second electrode and an alignment direction of the alignment layer intersects the second direction in 45 degrees to 85 degrees.

The invention further provides a display panel including a plurality of the above-mentioned pixel structures disposed the substrate, an opposite substrate, and a display medium. The opposite substrate is disposed opposite to the substrate. The display medium is disposed between the substrate and the opposite substrate and a thickness of the display medium in the transmissive display region is substantially identical to a thickness of the display medium in the reflective display region.

In light of the foregoing descriptions, the extending directions of the pattern of the electrode configured in the reflective display region and in the transmissive display region according to the invention are extended in two directions which are perpendicular to each other and the alignment layer provides a single alignment direction in the reflective display region and the transmissive display region. Accordingly, the pixel structure in the invention provides different effects on the display medium in the transmissive display region and the reflective display region so that desirable display effect can be achieved in the reflective display region and the transmissive display region. In addition, the thickness of the display medium in the display panel according to the invention is not required to be modulated for facilitating the trans-reflective display function.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a pixel structure according to a first embodiment of the invention.

FIG. 1A schematically shows a simulation relationship of the transmittance or the reflectivity of the LCD panel corresponding to the voltage when the LCD panel utilizes the pixel structure 100 depicted in FIG. 1.

FIG. 1B schematically shows a simulation relationship of the normalized transmittance or the normalized reflectivity of the LCD panel corresponding to the voltage when the LCD panel utilizes the pixel structure 100 depicted in FIG. 1, wherein the normalized transmittance and the normalized reflectivity are the measure values normalized by using the transmittance or the reflectivity measured at a voltage of 7V as a reference.

FIG. 1C schematically shows a simulation relationship of the transmittance or the reflectivity of the LCD panel corresponding to the voltage when the LCD panel utilizes the pixel structure 100 depicted in FIG. 1.

FIG. 1D schematically shows a simulation relationship of the normalized transmittance or the normalized reflectivity of the LCD panel corresponding to the voltage when the LCD panel utilizes the pixel structure 100 depicted in FIG. 1, wherein the normalized transmittance and the normalized reflectivity are the measure values normalized by using the transmittance or the reflectivity measured at a voltage of 7V as a reference.

FIG. 2 is a cross-sectional view of a pixel structure taken along sectional lines I-I′ and II-II′ of FIG. 1.

FIG. 3 is a schematic view of a pixel structure according to the second embodiment of the invention.

FIG. 4 schematically illustrates a pixel structure according to a third embodiment of the invention.

FIG. 5 is a cross-sectional view of a pixel structure taken along sectional lines III-III′ and IV-IV′ of FIG. 4.

FIG. 6 is a schematic view of a display panel according to an embodiment of the invention.

### DESCRIPTION OF EMBODIMENTS

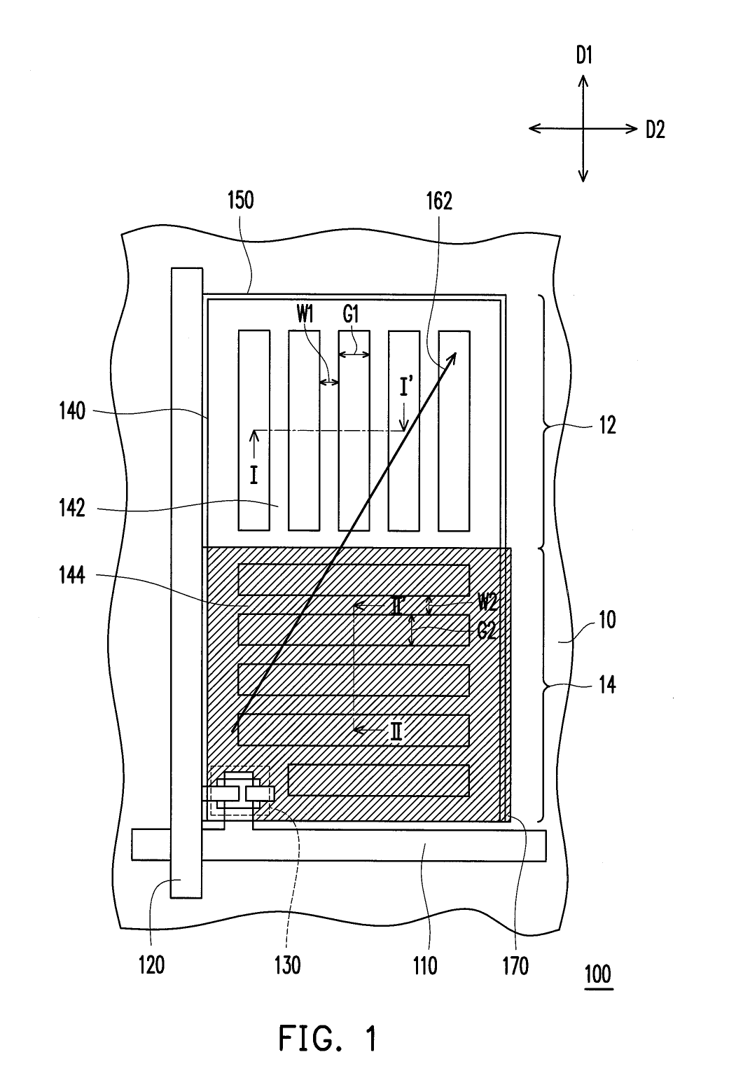

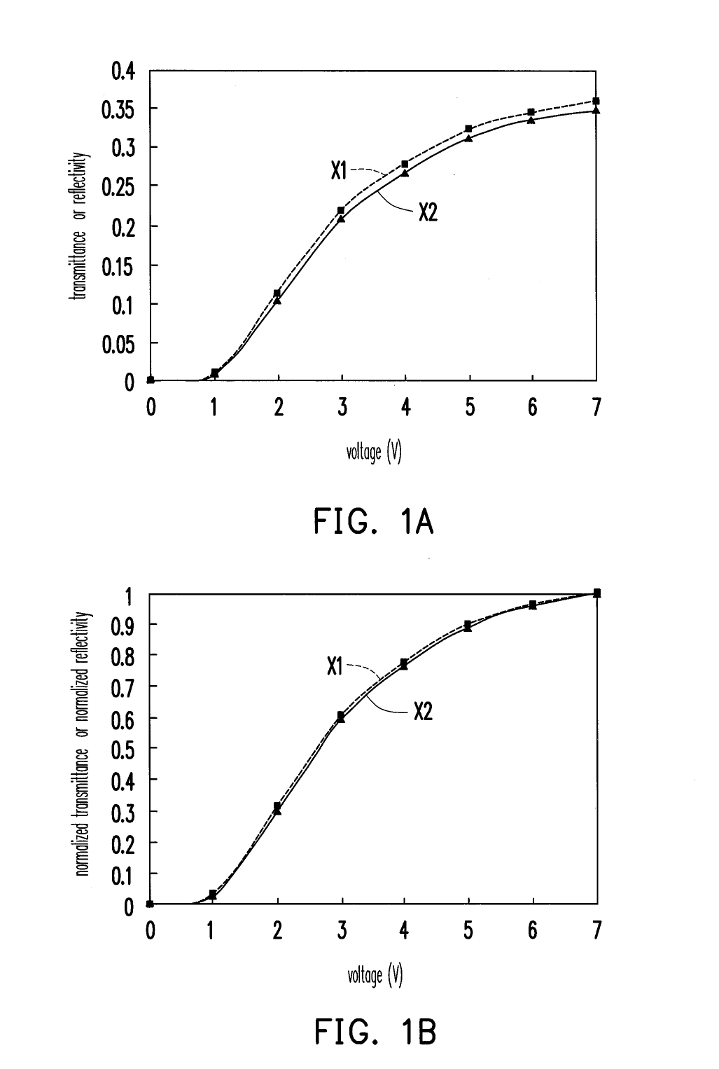

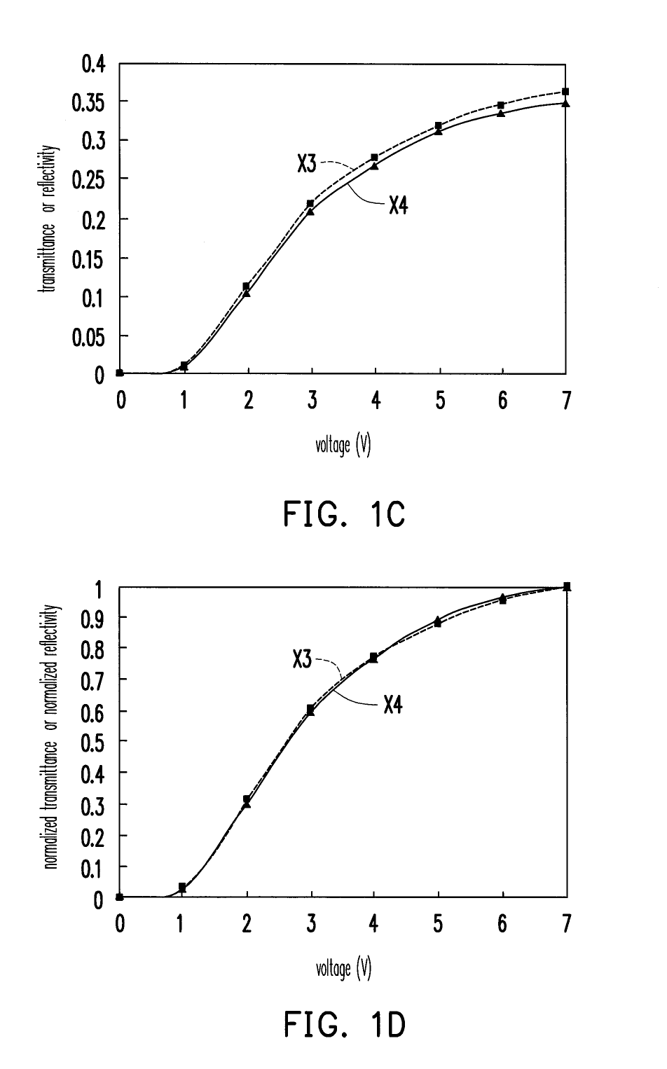

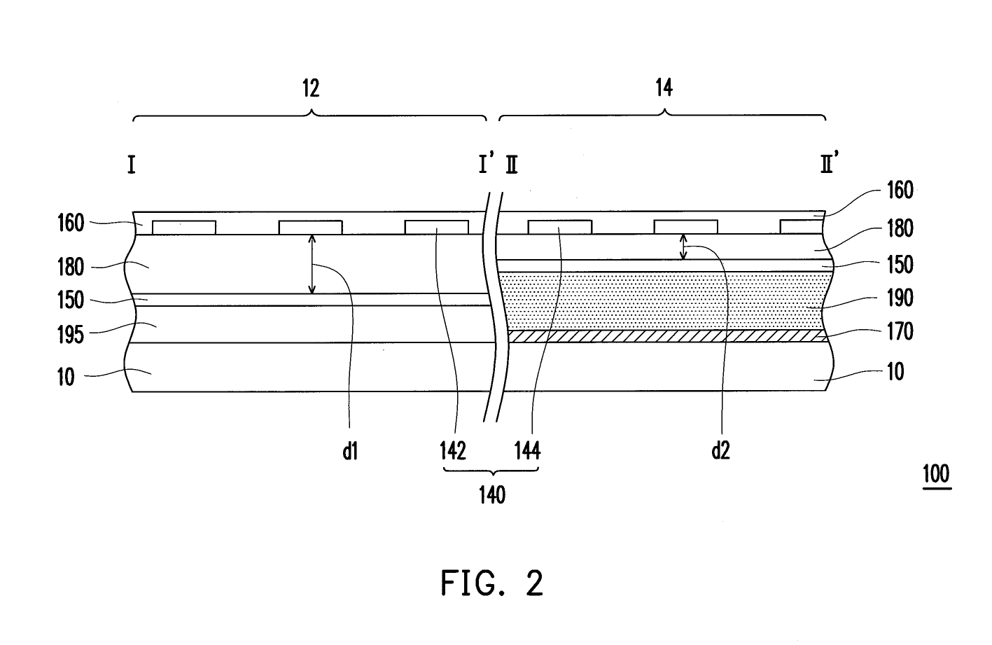

FIG. 1 schematically illustrates a pixel structure according to a first embodiment of the invention and FIG. 2 is a cross-sectional view of a pixel structure taken along sectional lines I-I′ and II-II′ of FIG. 1. Referring to FIG. 1 and FIG. 2 simultaneously, a pixel structure 100 is disposed on a substrate 10. The substrate 10 has a transmissive display region 12 and a reflective display region 14. The pixel structure 100 includes a scan line 110, a data line 120, an active device 130, a first electrode 140, a second electrode 150, and an alignment layer 160. The data line 120 intersects the scan line 110. The active device 130 is electrically connected to the scan line 110 and the data line 120. One of the first electrode 140 and the second electrode 150 is electrically connected to the active device 130 and the other of the first electrode 140 and the second electrode 150 is connected to a common voltage. The alignment layer 160 covers the first electrode 140 and the second electrode 150 and an alignment direction 162 of the alignment layer 160 intersects a second direction D2 in 45 degrees to 85 degrees. In one embodiment, the alignment direction 162 can intersect the second direction D2 in 60 degrees.

The first electrode 140 has a plurality of first stripe portions 142 located in the transmissive display region 12 and a plurality of second stripe portions 144 located in the reflective display region 14. Each of the first stripe portions 142 is extended in a first direction D1 and each of the second stripe portions 144 is extended in the second direction D2 while the first direction D1 is substantially perpendicular to the second direction D2. In the present embodiment, the first direction D1 and the second direction D2 are respectively a longitudinal direction and a transversal direction and the data line 120 is substantially parallel to the first direction D1. The second electrode 150 (generally the common electrode) can provide a shielding effect to shield the influence of the signal variance in the data line 120 on the electric field. As such, poor display quality would not be generated at the location between the data line 120 and the first electrode 140.

For providing the reflective display function in the reflective display region 14, the pixel structure 100 further includes a reflective layer 170. The reflective layer 170 is disposed in the reflective display region 14, located at a side of the first electrode 140 adjacent to the substrate 10, and located at a side of the second electrode 150 adjacent to the substrate 10. Ambient light can pass the first electrode 140 and subsequently irradiates on the reflective layer 170 to be served as the display light of the reflective display mode. It is noted that the disposition location of the reflective layer 170 is not specifically restricted in the invention. In an alternative embodiment, the reflective layer 170 can be selectively disposed on the other side of the substrate 10 away from the first electrode 140 and the second electrode 150.

In the present embodiment, the second electrode 150 is disposed between the first electrode 140 and the substrate 10 and the pixel structure 100 further includes a planar layer 180 disposed between the first electrode 140 and the second electrode 150. The first electrode 140 and the second electrode 150 are respectively located at two opposite sides of the planar layer 180. The gaps between the first stripe portions 142 and the gaps between the second stripe portions 144 are located above a partial area of the second electrode 150 so that the partial area of the second electrode 150 is not shaded by the first stripe portions 142 and the second stripe portions 144. The first electrode 140 and the second electrode 150 are applied by different voltages when the pixel structure 100 displays an image, and thus a transversal electric field can be formed between the first electrode 140 and the non-shaded second electrode 150 to drive a display medium for displaying the image. In short, the pixel structure 100 can be a fringe field switching (FFS) type pixel.

FIG. 1A and FIG. 1C schematically show simulation relationships of the transmittance or the reflectivity of the LCD panel corresponding to the voltage when the LCD panel utilizes the pixel structure 100 depicted in FIG. 1. FIG. 1B and FIG. 1D schematically show simulation relationships of the normalized transmittance or the normalized reflectivity of the LCD panel corresponding to the voltage when the LCD panel utilizes the pixel structure 100 depicted in FIG. 1 and the normalized transmittance and the normalized reflectivity are the measured values normalized by using the transmittance or the reflectivity measured at a voltage of 7V as a reference. In the simulation, the liquid crystal material used in the liquid crystal display panel has a dielectric coefficient of Δ∈=+8.2, the retardation (Δnd) of the liquid crystal layer is, for example, 0.41 μm, and a pre-tilt angle of the liquid crystal layer at the two opposite sides is 2 degrees. The alignment direction of the liquid crystal layer can be intersected with the second direction D2 depicted in FIG. 1 in 60 degrees. A single color light having a wavelength located at the center of the wavelength range of the visible light, i.e. 550 nm, is served as a simulation light of the LCD panel.

In the simulation having the results shown in FIG. 1A and FIG. 1B, the planar layer 180 of the pixel structure 100 has two thicknesses of 0.2 μm and 0.1 μm respectively in the transmissive display region 12 and the reflective display region 14 and a width W1 of each first stripe portion 142 as well as a width W2 of each second stripe portion 144 is 3 μm. In addition, a first distance G1 between two adjacent first stripe portions 142 and a second distance G2 between two adjacent second stripe portions 144 can be 5 μm. Herein, the curve X1 shows a variance of the transmittance according to the voltage and the curve X2 shows a variance of the reflectivity according to the voltage. As shown in the curve X1 and the curve X2, the modulation on the alignment direction and the thickness of the planar layer 180 under the same electrode pattern facilitates the LCD panel to have similar brightness variance no matter in a transmissive display mode or in a reflective display mode. In short, the gamma curves represented in the transmissive display region 12 and in the reflective display region 14 are substantially similar to each other.

In the simulation having the results shown in FIG. 1C and FIG. 1D, the planar layer 180 of the pixel structure 100 has one thicknesses of 0.1 μm both in the transmissive display region 12 and the reflective display region 14 and a width W1 of each first stripe portion 142 as well as a width W2 of each second stripe portion 144 is 3 μm. In addition, a first distance G1 between two adjacent first stripe portions 142 and a second distance G2 between two adjacent second stripe portions 144 can respectively be 3 μm and 5 μm. Herein, the curve X3 shows a variance of the transmittance according to the voltage and the curve X4 shows a variance of the reflectivity according to the voltage. Comparing the relationship between the curve X3 and the curve X4 and the relationship between the curve X1 and the curve X2 as shown in FIG. 1B and FIG. 1D, the curve X3 and the curve X4 have more consistent variance.

Accordingly, the pattern design of the electrode in deed has influence on the distribution of the electric field, especially in a FFS type pixel. If different display effects in the transmissive display region 12 and the reflective display region 14 are demanded, the first stripe electrodes 142 and the second stripe portions 144 of the first electrode 140 can have different patterns, e.g. having different widths, different gaps, etc. For example, the first distance G1 between two adjacent first stripe portions 142 and the second distance G2 between two adjacent second stripe portions 144 can be different. Alternately, the width W1 of each first stripe portion 142 can be selectively different to the width W2 of each second stripe portion 144.

In the present embodiment, a flat surface is formed by the configuration of the planar layer 180 so that the pixel structure 100 has substantially the same thickness in the transmissive display region 12 and the reflective display region 14. Furthermore, for adjusting the display effects in the transmissive display region 12 and the reflective display region 14, the thickness d1 of the planar layer 180 in the transmissive display region 12 can be greater than the thickness d2 of the planar layer 180 in the reflective display region 14. It is noted that the above descriptions are not intent to limit the scope of the invention. In an alternative embodiment, the planar layer 180 can have a uniformed thickness, i.e. the thickness d1 can be optionally identical to the thickness d2.

Furthermore, the pixel structure 100 further includes a λ/4 retardation layer 190. When the pixel structure 100 is applied in a display panel, an upper surface and a bottom surface of the display panel can be adhered with an upper polarizer and a bottom polarizer, wherein the transmissive axis of the upper polarizer is perpendicular to the transmissive axis of the bottom polarizer. Herein, the slow axis of the λ/4 retardation layer 190 can be intersected with the transmissive axis of the upper polarizer in the display panel in 45 degrees. In the pixel structure 100, the λ/4 retardation layer 190 is disposed in the reflective display region 14, located at a side of the first electrode 140 adjacent to the substrate 10, and located at a side of the second electrode 150 adjacent to the substrate 10. The disposition of the λ/4 retardation layer 190 between the reflective layer 170 and the planar layer 180 is conducive to maintain the black frame in the waiting state when the pixel structure 100 is a normally black pixel. In the transmissive display region 12, the pixel structure 100 further has an insulation layer 195 located between the second electrode 150 and the substrate 10. Nevertheless, the invention is not restricted thereto and the second electrode 150 in an alternative embodiment can be selectively directly disposed on the substrate 10 without the interposing of the insulation layer 195.

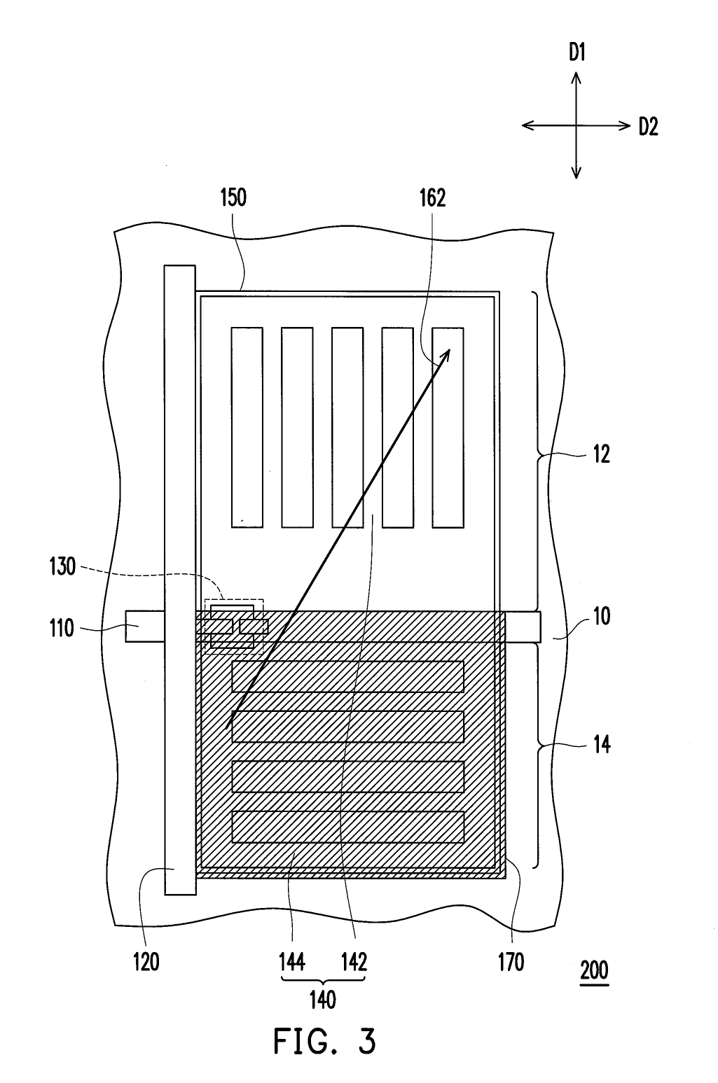

The scan line 110 in the present embodiment is arranged in the periphery of the pixel structure 100, but the invention is not limited thereto. FIG. 3 is a schematic view of a pixel structure according to the second embodiment of the invention. Referring to FIG. 3, the pixel structure 200, similar to the pixel structure 100, is disposed on a substrate 10. The main difference between the pixel structure 200 and the pixel structure 100 lies in that the disposition location of the scan line 110. In this embodiment, the scan line 110 is arranged between the transmissive display region 12 and the reflective display region 14 and the first electrode 140 crosses over the scan line 110, for example.

In specific, the first stripe portions 142 and the second stripe portions 144 of the first electrode 140 are respectively located at two opposite sides of the scan line 110. The scan line 110 can be served as the boundary of the reflective display region 14 and the transmissive display region 12 in the present embodiment. Generally, the scan line 110 can be fabricated by opaque conductive material. Once the display quality performed at the boundary between the reflective display region 14 and the transmissive display region 12 is poor, the disposition of the scan line 110 can shade the region having poor display quality so as to improve the display quality of the pixel structure 200.

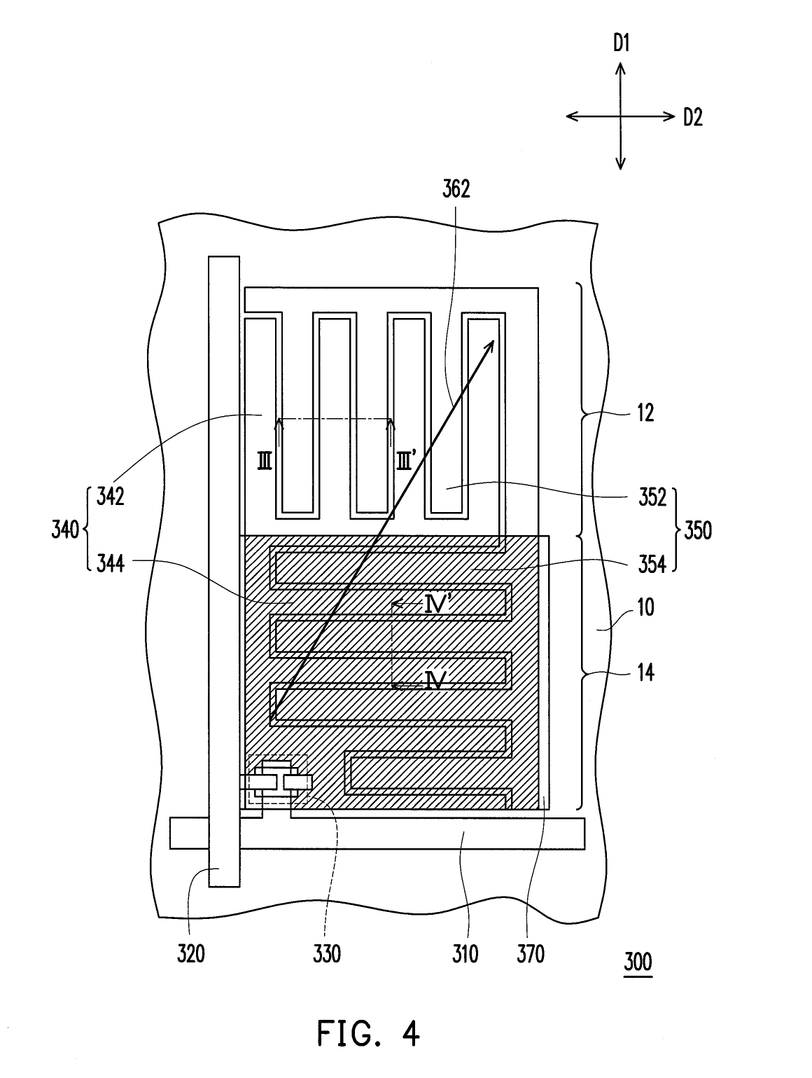

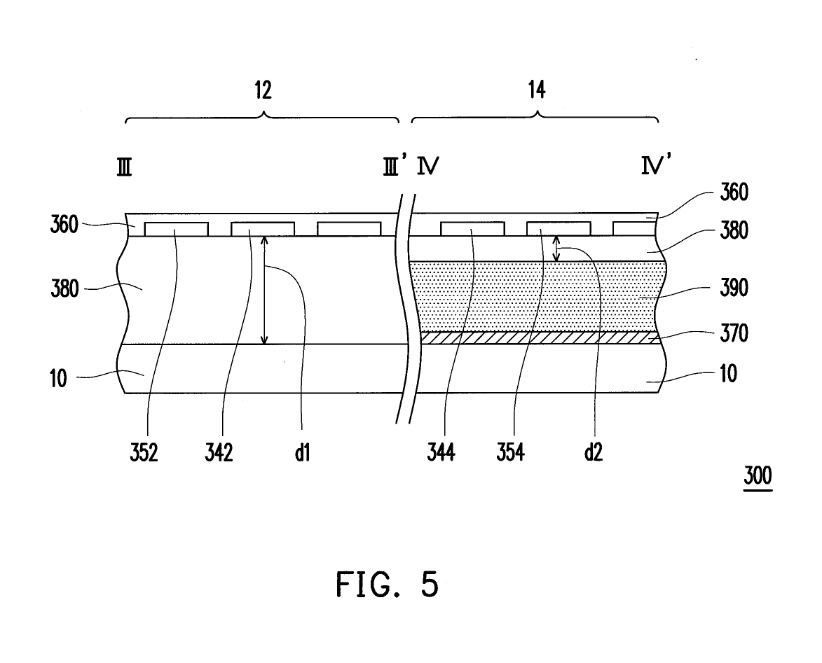

FIG. 4 schematically illustrates a pixel structure according to a third embodiment of the invention and FIG. 5 is a cross-sectional view of a pixel structure taken along sectional lines III-III′ and IV-IV′ of FIG. 4. Referring to FIG. 4 and FIG. 5, a pixel structure 300 is disposed on a substrate 10. The substrate 10 has a transmissive display region 12 and a reflective display region 14. The pixel structure 300 includes a scan line 310, a data line 320, an active device 330, a first electrode 340, a second electrode 350, and an alignment layer 360. The data line 320 intersects the scan line 310. The active device 330 is electrically connected to the scan line 310 and the data line 320. One of the first electrode 340 and the second electrode 350 is electrically connected to the active device 330 and the other of the first electrode 340 and the second electrode 350 is connected to a common voltage. The alignment layer 360 covers the first electrode 340 and the second electrode 350 and an alignment direction 362 of the alignment layer 360 intersects a second direction D2 in 45 degrees to 85 degrees. It is noted that the alignment direction 362 of the alignment layer 360 is consistent in the transmissive display region 12 and in the reflective display region 14. Therefore, no complicated alignment process is required to achieve multi-alignment directions.

The first electrode 340 has a plurality of first stripe portions 342 located in the transmissive display region 12 and a plurality of second stripe portions 344 located in the reflective display region 14. Each of the first stripe portions 342 is extended in a first direction D1 and each of the second stripe portions 344 is extended in the second direction D2 while the first direction D1 is substantially perpendicular to the second direction D2. Herein, the first direction D1 and the second direction D2 can respectively be a longitudinal direction and a transversal direction and the data line 320 is substantially parallel to the first direction D1. The second electrode 350 similarly has a plurality of third stripe portions 352 located in the transmissive display region 12 and a plurality of fourth stripe portions 354 located in the reflective display region 14. The first stripe portions 342 and the third stripe portions 352 are alternatively arranged and the second stripe portions 344 and the fourth stripe portions 354 are alternatively arranged. Accordingly, the first electrode 340 and the second electrode 350 in the pixel structure 300 are disposed co-planar.

For providing the reflective display function in the reflective display region 14, the pixel structure 300 further includes a reflective layer 370. The reflective layer 370 is disposed in the reflective display region 14, located at a side of the first electrode 340 adjacent to the substrate 10, and located at a side of the second electrode 350 adjacent to the substrate 10. That is to say, a user sees the image displayed by the pixel structure 100 in a direction from the first electrode 340 pointing towards the reflective layer 370. It is noted that the disposition location of the reflective layer 370 is not specifically restricted in the invention. In an alternative embodiment, the reflective layer 370 can be selectively disposed on the other side of the substrate 10 away from the first electrode 140 and the second electrode 150.

In the present embodiment, the pixel structure 300 further includes a planar layer 380 between the substrate 10 and the electrodes 340 and 350. A flat surface is formed by the configuration of the planar layer 380 so that the pixel structure 300 has substantially the same thickness in the transmissive display region 12 and the reflective display region 14. In the present embodiment, the thickness d1 of the planar layer 380 in the transmissive display region 12 can be different from (greater than, for example,) the thickness d2 of the planar layer 380 in the reflective display region 14. It is noted that the above descriptions are not intent to limit the scope of the invention. In an alternative embodiment, the planar layer 380 can have a uniformed thickness, i.e. the thickness d1 can be optionally identical to the thickness d2.

In addition, the pixel structure 300 further includes a λ/4 retardation layer 390 disposed in the reflective display region 14 and located between the reflective layer 170 and the planar layer 380. The disposition of the λ/4 retardation layer 390 is conducive to maintain the black frame in the waiting state when the pixel structure 300 is a normally black pixel. When the pixel structure 300 is applied in a display panel, an upper surface and a bottom surface of the display panel can be adhered with an upper polarizer and a bottom polarizer and the slow axis of the λ/4 retardation layer 390 intersects the transmissive axis of the upper polarizer in 45 degrees. The transmissive axis of the upper polarizer is perpendicular to the transmissive axis of the bottom polarizer. As a whole, the main difference between the pixel structure 300 and the pixel structure 100 lies in that the disposition location of the electrodes. In an alternative embodiment, the scan line 310 can be selectively disposed between the transmissive display region 12 and the reflective display region 14.

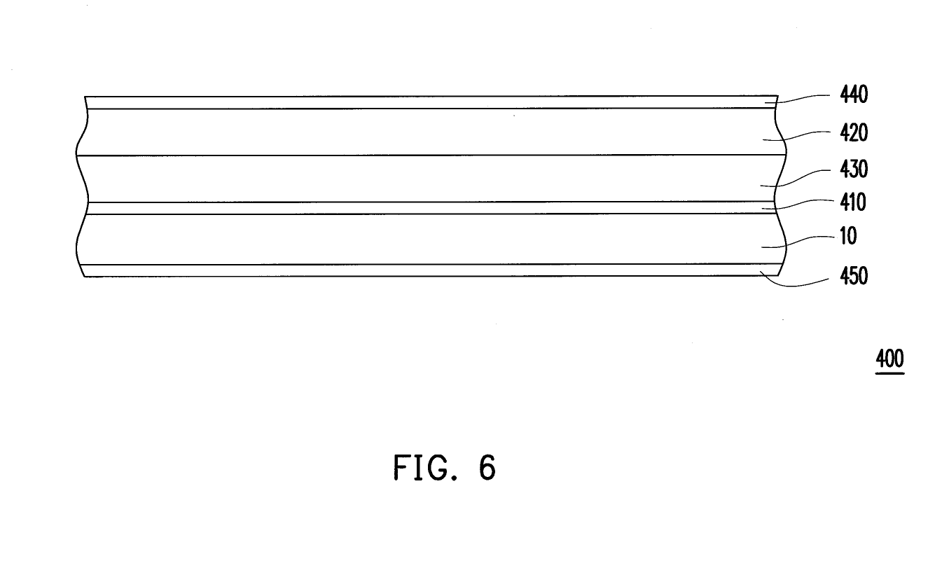

FIG. 6 is a schematic view of a display panel according to an embodiment of the invention. Referring to FIG. 6, the display panel 400 includes a substrate 10, a plurality of pixel structures 410 disposed on the substrate 10, an opposite substrate 420, the display medium 430, and the polarizers 440 and 450. The display medium 430 is disposed between the substrate 10 and the opposite substrate 420 and the polarizers 440 and 450 are disposed at the outer side of the display panel 400. The pixel structures 410 disposed on the substrate 10 can be selected from the pixel structures 100, 200, or 300 described in the aforesaid embodiments, or the pixel structures derived from the design of the pixel structures 100, 200, or 300. The display medium 430 can be a liquid crystal material. The opposite substrate 420 can be further disposed with a color filter layer (not shown) for facilitating to display colorful images. Furthermore, an upper polarizer (not shown) and a bottom polarizer (not shown) can be selectively adhered on the upper surface and the bottom surface of the display panel 400.

It is noted that the thickness of the pixel structures in the transmissive display region 12 and that in the reflective display region 14 are the same to each other so that the display medium 430 can have a uniformed thickness in the present embodiment in the transmissive display region 12 and in the reflective display region 14, which is conducive to render the display panel 400 have desirable display quality. In other words, in no need of a multi-cell gap design, the display panel 400 can have substantially similar display effects in the reflective display region 14 and the transmissive display region 12. Accordingly, the complicated fabrication process is omitted and the uneven display quality due to the change in thickness of the display medium 430 can be prevented.

In view of the above, the patterns of the electrode in the transmissive display region and the reflective display region are extended in two directions perpendicular to each other in the invention, and the alignment layer provides a same alignment direction in the transmissive display region and the reflective display region. Therefore, desirable display quality of the pixel structure can be achieved in both the reflective display region and the transmissive display region. When the pixel structure is applied in a display panel, the display medium having a uniformed thickness conduces to achieve the trans-reflective display function. Accordingly, simple fabrication process and desirable display quality can be accomplished.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A pixel structure disposed on a substrate, the substrate having a transmissive display region and a reflective display region, and the pixel structure comprising:
a scan line;
a data line intersecting the scan line;
an active device electrically connected to the scan line and the data line;
a first electrode having a plurality of first stripe portions located in the transmissive display region and a plurality of second stripe portions located in the reflective display region, each of the first stripe portions being extended in a first direction, each of the second stripe portions being extended in a second direction, and the first direction being substantially perpendicular to the second direction;
a second electrode, one of the first electrode and the second electrode being electrically connected to the active device and the other of the first electrode and the second electrode being connected to a common voltage; and
an alignment layer covering the first electrode and the second electrode and an alignment direction of the alignment layer intersecting the second direction in 45 degrees to 85 degrees.

2. The pixel structure as claimed in claim 1, further comprising a reflective layer disposed in the reflective display region, and located at a side of the first electrode adjacent to the substrate and a side of the second electrode adjacent to the substrate.

3. The pixel structure as claimed in claim 1, further comprising a λ/4 retardation layer disposed in the reflective display region and located at a side of the first electrode adjacent to the substrate and a side of the second electrode adjacent to the substrate.

4. The pixel structure as claimed in claim 1, further comprising a planar layer disposed between the first electrode and the substrate.

5. The pixel structure as claimed in claim 4, wherein the second electrode is located between the planar layer and the substrate, and a first height of the planar layer in the transmissive display region is different from a second height of the planar layer in the reflective display region.

6. The pixel structure as claimed in claim 4, further comprising an insulation layer disposed in the transmissive display region and the insulation layer being located between the second electrode and the substrate.

7. The pixel structure as claimed in claim 4, wherein the first electrode and the second electrode are substantially co-planar with each other, the second electrode has a plurality of third stripe portions located in the transmissive display region and a plurality of fourth stripe portions located in the reflective display region, the first stripe portions and the third stripe portions are alternatively arranged, and the second stripe portions and the fourth stripe portions are alternatively arranged.

8. The pixel structure as claimed in claim 1, wherein a first distance between two adjacent first stripe portions is not identical to a second distance between two adjacent second stripe portions.

9. The pixel structure as claimed in claim 1, wherein a width of each first stripe portion is not identical to a width of each second stripe portion.

10. The pixel structure as claimed in claim 1, wherein the data line is substantially parallel to the first direction.

11. The pixel structure as claimed in claim 1, wherein the scan line is located between the transmissive display region and the reflective display region and the first electrode crosses over the scan line.

12. A display panel, comprising:
a plurality of the pixel structures as claimed in claim 1 disposed on the substrate;
an opposite substrate disposed opposite to the substrate; and
a display medium disposed between the substrate and the opposite substrate and a thickness of the display medium in the transmissive display region being substantially identical to a thickness of the display medium in the reflective display region.
